(19) United States
(12) Patent Application Publication
(10) Pub. No.: US 2016/0188811 A1
(43) Pub. Date: Jun. 30, 2016

(54) CLINICAL TRIAL MANAGEMENT

(71) Applicant: CERNER INNOVATION, INC., KANSAS CITY, KS (US)

(72) Inventors: DOUGLAS W. WAGER, KANSAS CITY, MO (US); SARA JANE GRIFFIN, LEE'S SUMMIT, MO (US); RYAN M. MOOG, OLATHE, KS (US); MARSHA LAIRD-MADDOX, KANSAS CITY, MO (US)

(21) Appl. No.: 14/587,253

(22) Filed: Dec. 31, 2014

(51) Int. Cl. G06F 19/00

(52) U.S. Cl. CPC G06F 19/324

(57) ABSTRACT

Methods are directed at utilizing a cloud-based application for notifying a healthcare provider, such as a hospital or urgent care facility, that one or more patients from the healthcare provider qualify for clinical trial participation. A cloud-based application is also utilized for notifying one or more clinical trial sponsors, such as a university or pharmaceutical company, that one or more patients from one or more healthcare providers fulfill clinical trial eligibility. Furthermore, a cloud-based application is utilized for notifying one or more clinical trial sponsors that one or more patients of a second healthcare provider match the qualifications of one or more clinical trials, wherein at least one match was identified from a first healthcare provider.

### BACKGROUND

Clinical trials are valuable to advancing patient healthcare. To run effective clinical trials, participants (e.g., patients and/or people) meeting specific criteria are needed. Recruiting participants to partake in clinical trials, however, can be costly and time consuming. Some estimates indicate that recruitment delays can cost a clinical trial sponsor (e.g., a pharmaceutical company) up to one million dollars per day. Further, the lengthy process to recruit participants can delay completion of clinical trials. Nearly half of clinical trial delays result from participant enrollment problems. Such delays in performing clinical trials can result in slowing drug development, impeding healthcare research, and/or prolonging release of a new healthcare product into the market for use by patients that may benefit.

Recruitment delays oftentimes result from an inability to find potential participants that meet the criteria established for a clinical trial. Further, the number of potential participants for a clinical trial may be limited due to stringent eligibility criteria used to identify participants for the clinical trial. In such cases, inclusion criteria can be too difficult to meet or exclusion criteria may eliminate a large number of potential candidates resulting in lower than anticipated patient recruitment rates. Thus, there is a high demand for identifying participants that match the specific clinical trial eligibility requirements of a given clinical trial that is arranged by a clinical trial sponsor, such as a pharmaceutical company.

To recruit clinical trial participants, many clinical trial sponsors will turn to healthcare providers (e.g., hospitals) to obtain the desired number of participants for any given clinical trial. Thus, there is a high demand for identifying patients within a healthcare provider that match the specific clinical trial eligibility requirements of a given clinical trial that is arranged by a clinical trial sponsor.

### BRIEF SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

Embodiments of the present invention relate to identifying clinical trial participants that qualify for a given clinical trial. In one embodiment, there is a method for utilizing a cloud-based application for notifying a healthcare provider that one or more patients from the healthcare provider qualify for clinical trial participation. In another embodiment, a cloud-based application is utilized for the following: receiving from a clinical trial sponsor, clinical trial participation qualifications for a patient to enroll in a clinical trial; accessing an electronic medical record (EMR) information of the one or more patients form a first healthcare provider; screening the EMR information of the one or more patients from the first healthcare provider for matching clinical trial participation qualifications; determining that one or more patients of the first healthcare provider qualifies for clinical trial participation of the clinical trial sponsor, wherein the qualification for clinical trial participation is based on the matching of the EMR information of the one or more patients and the clinical trial participation qualifications and notifying to the first healthcare provider that the one or more patients from the first healthcare provider qualifies for clinical trial participation.

In another embodiment, there is a method in a medical information computing environment for utilizing a cloud-based application for notifying one or more clinical trial sponsors that one or more patients from one or more healthcare providers fulfill clinical trial eligibility. In one embodiment there is a method for utilizing the cloud-based application for the following: accessing an electronic medical record (EMR) for the one or more patients of the one or more healthcare providers; uploading the clinical trial eligibility requirements of the one or more clinical trials from the one or more clinical trial sponsors; matching the one or more patients to the one or more clinical trials in which the one or more patients are eligible to participate, based on: A) the EMR information of the one or more patients, and B) the clinical trial eligibility requirements from the one or more clinical trial sponsors; upon a request from the one or more clinical trial sponsors for a match of the one or more patients to the one or more clinical trials, requiring a fee be paid to the one or more healthcare providers for accessing the matching of the one or more patients to the one or more clinical trials, wherein the matching indicates that the one or more patients are eligible to participate in the one or more clinical trials; and upon payment of the fee from the one or more clinical trial sponsors, notifying the one or more clinical trial sponsors of the one or more patients that fulfill the clinical trial eligibility requirements of the one or more clinical trials.

In a further embodiment, there is a method in a medical information computing environment for utilizing a cloud-based application for notifying one or more clinical trial sponsors that one or more patients of a second healthcare provider match the qualifications for a clinical trial in which at least one match was identified from a first healthcare provider. In one embodiment there is a method for utilizing the cloud-based application for the following: accessing an electronic medical record (EMR) information for the one or more patients from the first healthcare provider; uploading clinical trial qualifications from the one or more clinical trial sponsors; comparing the EMR for the one or more patients of the first healthcare provider and the clinical trial qualifications from one or more clinical trial sponsors; identifying matches between the EMR information for the one or more patients of the first healthcare provider and the clinical trial qualifications from the one or more clinical trial sponsors; identifying a clinical trial for one or more patients of a second healthcare provider that is different than the first healthcare provider; referring the one or more patients of the first healthcare provider to the second healthcare provider; and notifying the one or more clinical trial sponsors that the one or more patients of the second healthcare provider match the qualifications for the one or more clinical trials, wherein at least one match was identified from the first healthcare provider.

### BRIEF DESCRIPTION OF THE SEVERAL VIEWS OF THE DRAWINGS

FIG. 1 is a schematic diagram of a suitable computing system environment for use in implementing the present invention;

FIG. 2 is a flow diagram illustrating a method for notifying a healthcare provider of patients that have qualified for a clinical trial conducted by a clinical trial sponsor;

FIG. 3 is a schematic diagram illustrating a method for notifying a healthcare provider of patients that have qualified for a clinical trial conducted by a clinical trial sponsor;

FIG. 4 is a flow diagram illustrating a method for notifying a clinical trial sponsor of patients that have qualified for a clinical trial conducted by the same clinical trial sponsor;

FIG. 5 is a schematic diagram illustrating a method for notifying clinical trial sponsors of patients that have qualified for a clinical trial conducted by the same clinical trial sponsors.

FIG. 6 is a flow diagram illustrating a method for notifying a clinical trial sponsor of patients that have qualified for a clinical trial conducted by the same clinical trial sponsor;

FIG. 7 is a schematic diagram illustrating a method for notifying clinical trial sponsors of patients that have qualified for a clinical trial conducted by the same clinical trial sponsors.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

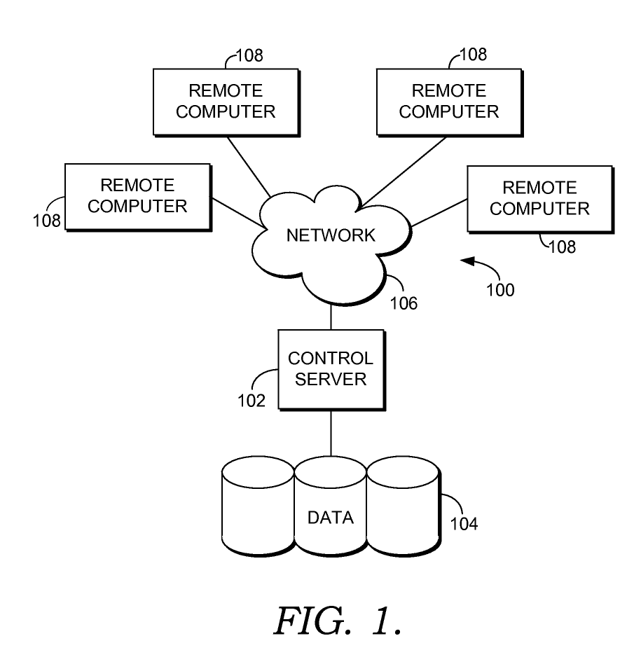

An exemplary computing environment suitable for use in implementing embodiments of the present invention is described below. FIG. 1 is an exemplary computing environment (e.g., medical-information computing-system environment) with which embodiments of the present invention may be implemented. The computing environment is illustrated and designated generally as reference numeral 100. The computing environment 100 is merely an example of one suitable computing environment and is not intended to suggest any limitation as to the scope of use or functionality of the invention. Neither should the computing environment 100 be interpreted as having any dependency or requirement relating to any single component or combination of components illustrated therein.

The present invention might be operational with numerous other purpose computing system environments or configurations. Examples of well-known computing systems, environments, and/or configurations that might be suitable for use with the present invention include personal computers, server computers, hand-held or laptop devices, multiprocessor systems, microprocessor-based systems, set top boxes, programmable consumer electronics, network PCs, minicomputers, mainframe computers, distributed computing environments that include any of the above-mentioned systems or devices, and the like.

The present invention might be described in the general context of computer-executable instructions, such as program modules, being executed by a computer. Exemplary program modules comprise routines, programs, objects, components, and data structures that perform particular tasks or implement particular abstract data types. The present invention might be practiced in distributed computing environments where tasks are performed by remote processing devices that are linked through a communications network. In a distributed computing environment, program modules might be located in association with local and/or remote computer storage media (e.g., memory storage devices).

With continued reference to FIG. 1, the computing environment 100 comprises a computing device in the form of a control server 102. Exemplary components of the control server 102 comprise a processing unit, internal system memory, and a suitable system bus for coupling various system components, including data store 104, with the control server 102. The system bus might be any of several types of bus structures, including a memory bus or memory controller, a peripheral bus, and a local bus, using any of a variety of bus architectures. Exemplary architectures comprise Industry Standard Architecture (ISA) bus, Micro Channel Architecture (MCA) bus, Enhanced ISA (EISA) bus, Video Electronic Standards Association (VESA) local bus, and Peripheral Component Interconnect (PCI) bus, also known as Mezzanine bus.

The control server 102 typically includes therein, or has access to, a variety of non-transitory computer-readable media. Computer-readable media can be any available media that might be accessed by control server 102, and includes volatile and nonvolatile media, as well as, removable and nonremovable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by control server 102. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

The control server 102 might operate in a computer network 106 using logical connections to one or more remote computers 108. Remote computers 108 might be located at a variety of locations in a medical or research environment, including clinical laboratories (e.g., molecular diagnostic laboratories), hospitals and other inpatient settings, veterinary environments, ambulatory settings, medical billing and financial offices, hospital administration settings, home healthcare environments, and clinicians' offices. Clinicians may comprise a treating physician or physicians; specialists such as surgeons, radiologists, cardiologists, and oncologists; emergency medical technicians; physicians' assistants; nurse practitioners; nurses; nurses' aides; pharmacists; dieticians; microbiologists; laboratory experts; laboratory technologists; genetic counselors; researchers; veterinarians; students; and the like. The remote computers 108 might also be physically located in nontraditional medical care environments so that the entire healthcare community might be capable of integration on the network. The remote computers 108 might be personal computers, servers, routers, network PCs, peer devices, other common network nodes, or the like and might comprise some or all of the elements described above in relation to the control server 102. The devices can be personal digital assistants or other like devices.

Computer networks 106 comprise local area networks (LANs) and/or wide area networks (WANs). Such networking environments are commonplace in offices, enterprise-wide computer networks, intranets, and the Internet. When utilized in a WAN networking environment, the control server 102 might comprise a modem or other means for establishing communications over the WAN, such as the Internet. In a networking environment, program modules or portions thereof might be stored in association with the control server 102, the data store 104, or any of the remote computers 108. For example, various application programs may reside on the memory associated with any one or more of the remote computers 108. It will be appreciated by those of ordinary skill in the art that the network connections shown are exemplary and other means of establishing a communications link between the computers (e.g., control server 102 and remote computers 108) might be utilized.

In operation, an organization might enter commands and information into the control server 102 or convey the commands and information to the control server 102 via one or more of the remote computers 108 through input devices, such as a keyboard, a pointing device (commonly referred to as a mouse), a trackball, or a touch pad. Other input devices comprise microphones, satellite dishes, scanners, or the like. Commands and information might also be sent directly from a remote healthcare device to the control server 102. In addition to a monitor, the control server 102 and/or remote computers 108 might comprise other peripheral output devices, such as speakers and a printer.

Although many other internal components of the control server 102 and the remote computers 108 are not shown, such components and their interconnection are well known. Accordingly, additional details concerning the internal construction of the control server 102 and the remote computers 108 are not further disclosed herein.

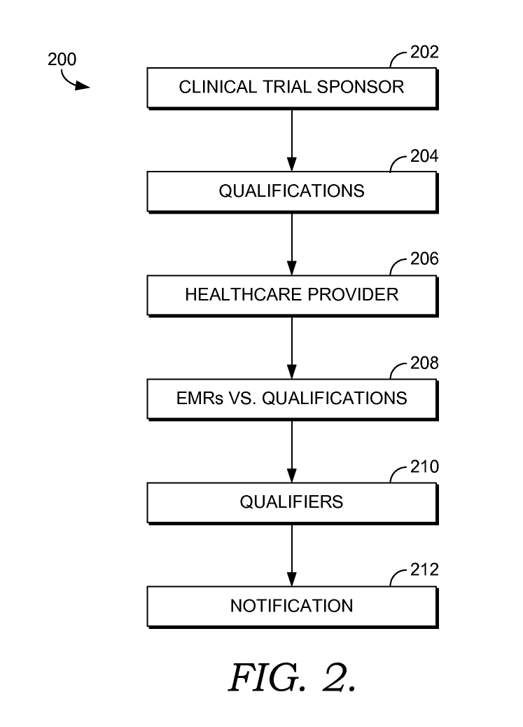

Turning now to FIG. 2, notifying a healthcare provider that it has patients that qualify for a clinical trial utilizing a cloud-based application is illustrated as a block diagram 200. At step 202, a clinical trial sponsor, such as a pharmaceutical company, the Food and Drug Administration (FDA), and the like, sends its clinical trial qualifications 204 to a cloud-based application (not shown). At step 206, a healthcare provider, such as a hospital, urgent care facility, pediatrician's office, and the like, receives the clinical trial qualifications 204. At step 208, one or more EMRs of one or more patients of the healthcare provider are compared to the clinical trial qualifications. At step 212, the healthcare provider is notified of the patients that qualified for the clinical trial 210.

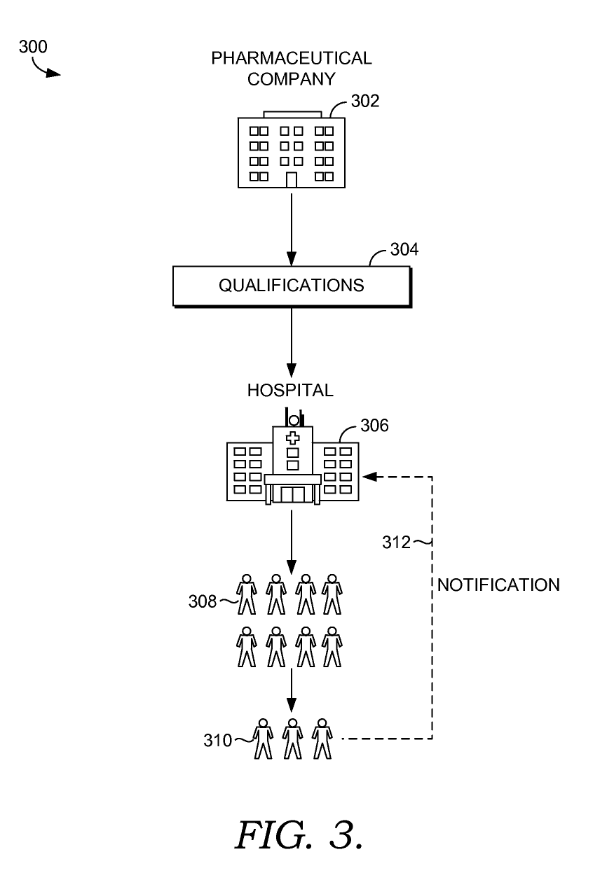

Turning now to FIG. 3, illustrated is the notification that a hospital has patients that qualify for a clinical trial utilizing a cloud-based application 300. In one embodiment, a pharmaceutical company 302 sends clinical trial participation qualifications 304 to a cloud-based application (not shown). In a further embodiment, the clinical trial participation qualifications 304 are then sent to the hospital 306. In another embodiment, the hospital 306 compares its one or more EMRs of its patient population 308 to the clinical trial participation qualifications 304. In one embodiment, the hospital 306 is notified 312 that one or more patients qualified for the clinical trial 310.

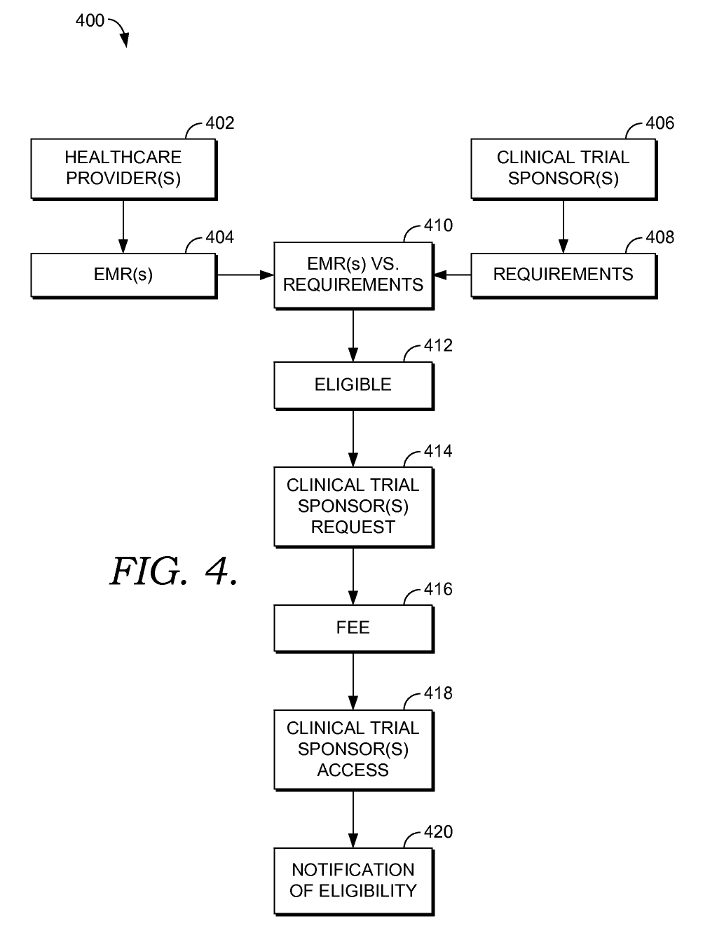

In one embodiment, the clinical trial sponsor is notified of the one or more patients qualifying for the clinical trial participation from the first healthcare provider upon patient consent. In another embodiment, a cloud-based application is utilized for the following: accessing the EMR information of one or more patients from a second healthcare provider; screening the EMR information of the one or more patients from the second healthcare provider for matching clinical trial participation qualifications; determining that the one or more patients of the second healthcare provider that qualifies for clinical trial participation is based on the matching of the EMR information of the one or more patients and the clinical trial participation qualifications; and notifying to the second healthcare provider that the one or more patients from the second healthcare provider qualifies for clinical trial participation. In one embodiment, instead of notifying the first healthcare provider that one or more patients from the first healthcare provider qualifies for clinical trial participation, the notifying is the notifying of the clinical trial sponsor of a group of patients who qualify for the clinical trial. In a further embodiment, based on the group of patients who qualify for the clinical trial, the healthcare provider requests to participate in the clinical trial. In another embodiment, wherein the notifying of the clinical trial sponsor of a group of patients who qualify for the clinical trial, the group of patients who qualify for the clinical trial are actually enrolled in the clinical trial of the first healthcare provider. It will be appreciated that system can filter out and not screen records of patients who have indicated they are “not interested”. For example, some patients may be opposed to their data being screened without their knowledge (for any purpose) and/or some patients opposed to clinical research/clinical trials so their information would be filtered out before the processes described in FIG. 4.

Turning to FIG. 4, illustrated is the notification to one or more clinical trial sponsors that one or more patients from one or more healthcare providers fulfill clinical trial eligibility by utilizing a cloud-based application 400. In one embodiment, EMR(s) 404 from one or more patients of the one or more healthcare providers 402 is accessed utilizing a cloud-based application (not shown). Next, clinical trial eligibility requirements 408 of the one or more clinical trials from the one or more clinical trial sponsors 406 are uploaded utilizing a cloud-based application (not shown). At steps 410 and 412, one or more patients are matched to the one or more clinical trials in which they are eligible to participate, based on the EMR information and the clinical trial eligibility requirements from the one or more clinical trial sponsors.

At step 414, the clinical trial sponsors request a match of the one or more patients to the one or more clinical trials. At step 416, a fee is paid to the one or more healthcare providers by the one or more clinical trial sponsors for access 418 to the matching of one or more patients that are eligible to participate in the one or more clinical trials. Lastly, at step 420, the one or more clinical trial sponsors are notified of the one or more patients that fulfill the clinical trial eligibility requirements of the one or more clinical trials.

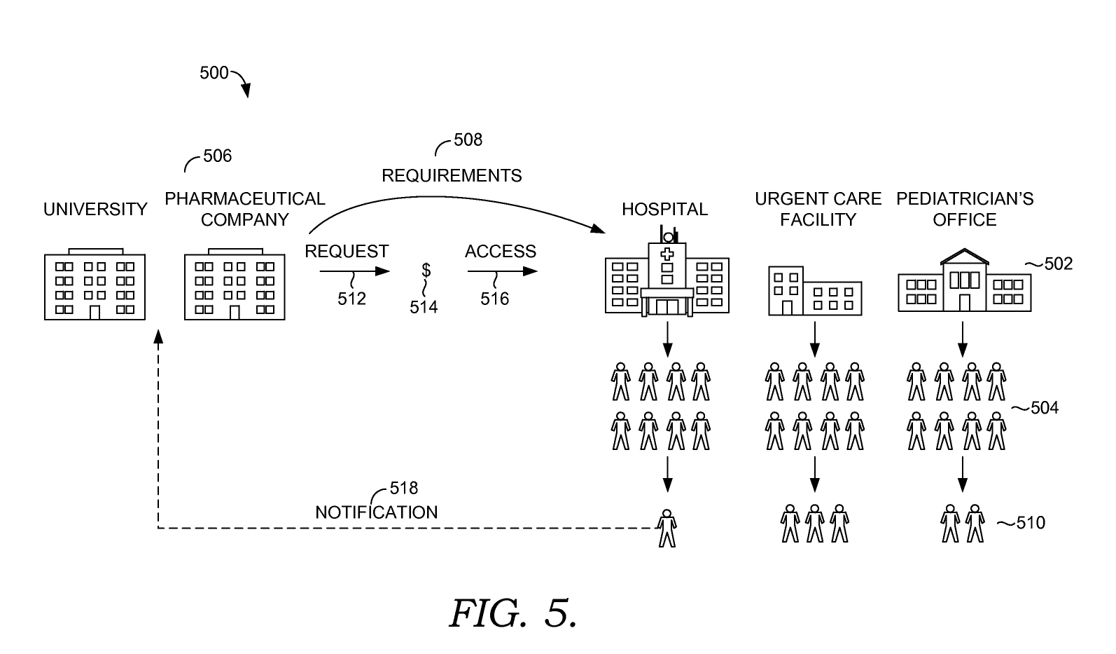

Turning now to FIG. 5, illustrated is the notification to a university (or college) and a pharmaceutical company that patients from a hospital, an urgent care facility and a pediatrician's office fulfill clinical trial eligibility by utilizing a cloud-based application 500. In one embodiment, the EMRs of the patients 504 of the hospital, urgent care facility and pediatrician's office 502 is accessed utilizing a cloud-based application (not shown). In a further embodiment, clinical trial eligibility requirements 508 of the one or more clinical trials from the university and the pharmaceutical company 506 are uploaded utilizing a cloud-based application (not shown). In another embodiment, patients 504 of the hospital, urgent care facility and the pediatrician's office 502 are matched to the one or more clinical trials in which they are eligible to participate 510, based on the EMR information and the clinical trial eligibility requirements from the university and the pharmaceutical company 506. In an embodiment, the university and the pharmaceutical company 506 request a match of the patients to the one or more clinical trials 512. In a further embodiment, a fee (of monetary value) is paid 514 to the hospital, urgent care facility and the pediatrician's office by the university and pharmaceutical company for access 516 to the matching of patients that are eligible to participate in the one or more clinical trials 510. In another embodiment, the university and pharmaceutical company are notified 518 of the patients that fulfill the clinical trial eligibility requirements of the one or more clinical trials.

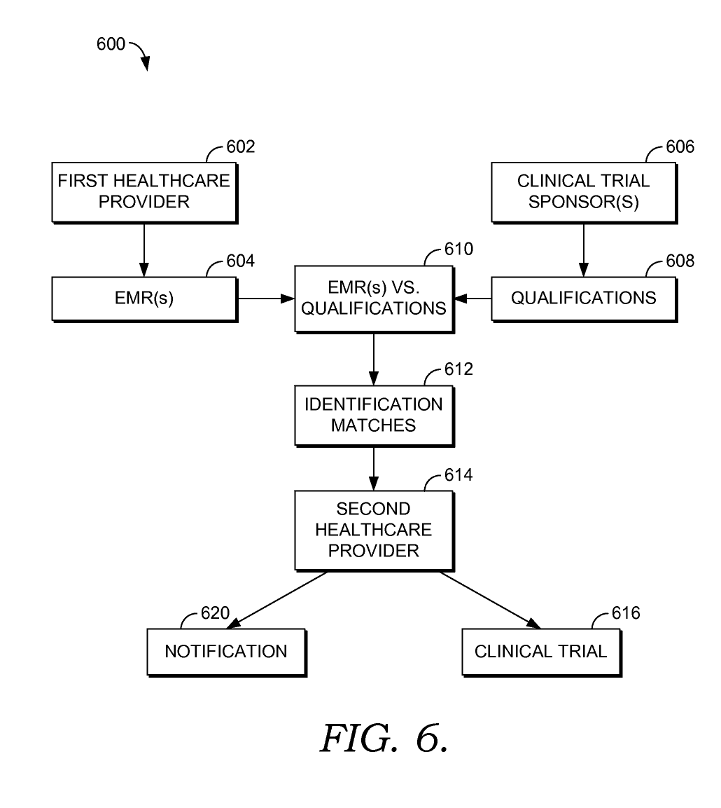

Turning now to FIG. 6, illustrated is the notification, by utilizing a cloud-based application, of one or more clinical trial sponsors that one or more patients of a second healthcare provider match the qualifications for one or more clinical trials, wherein at least one match was identified from a first healthcare provider 600. At steps 602 and 604, the EMR information for one or more patients from the first healthcare provider is accessed utilizing a cloud-based application (not shown). Next, clinical trial qualifications 608 from the one or more clinical trial sponsors 606 are uploaded utilizing a cloud-based application (not shown). At step 610, the EMR for the one or more patients of the first healthcare provider and the clinical trial qualifications from one or more clinical trial sponsors is compared. At step 612, matches between the EMR information for the one or more patients of the first healthcare provider and the clinical trial qualifications from the one or more clinical trial sponsors are identified. At steps 614 and 616, a clinical trial for one or more patients of a second healthcare provider that is different than the first healthcare provider is identified. At step 618, the one or more patients of the first healthcare provider are referred to the second healthcare provider. At step 620, the one or more clinical trial sponsors are notified that the one or more patients of the second healthcare provider match the qualifications for the one or more clinical trials, wherein at least one match was identified from the first healthcare provider.

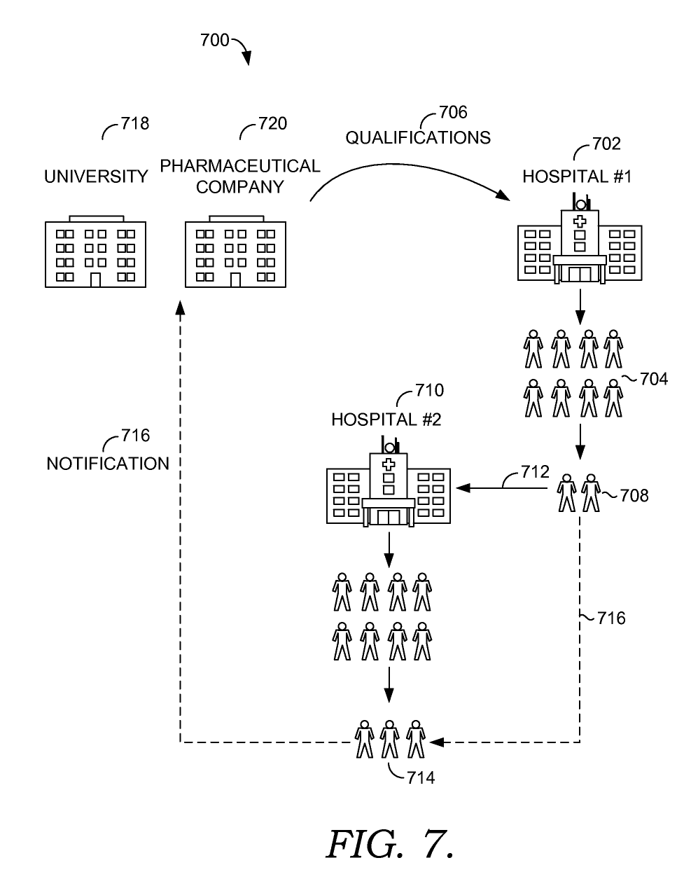

Turning to FIG. 7, illustrated is the notification to a university and a pharmaceutical company that the patients of the second hospital match the qualifications for the one or more clinical trials, wherein at least one match was identified from the first hospital 700. At steps 702 and 704, the EMRs of the patients from the first hospital are accessed utilizing a cloud-based application (not shown). At step 706, clinical trial qualifications from the university and pharmaceutical company are uploaded utilizing a cloud-based application (not shown) and the first hospital is notified of the clinical trial qualifications. Next, the EMRs for the patients of the first hospital and the clinical trial qualifications from the university and the pharmaceutical company are compared (not shown). At step 708, matches between the EMR information for the patients of the first hospital and the clinical trial qualifications from the university and pharmaceutical company are identified. At step 710, a clinical trial for patients of a second hospital is identified. Next, patients of the first hospital are referred to the second hospital 712. At steps 714 and 716, the university 718 and pharmaceutical company 720 are notified that patients of the second hospital 714 match the qualifications for the one or more clinical trials, wherein at least one match was identified from the first hospital 716.

In one embodiment, individuals of the first healthcare provider are compensated through the Meaningful Use policy. The Meaningful Use policy can be defined as using electronic health record (EHR) technology to improve quality, safety, efficiency, and reduce health disparities, engage patients and family, maintain privacy and security of patient health information, and improve care coordination, and population and public health. Ultimately, it is hoped that the Meaningful Use compliance will result in improved population health outcomes, better clinical outcomes, increased transparency and efficiency, empowered individuals, and more robust research data on health systems. The Meaningful Use policy is an incentive program in which the Centers for Medicare & Medicaid Services can award incentive payments to eligible professionals, such as doctors, who demonstrate Meaningful Use of an EHR. Thus, in one embodiment, a first hospital refers patients that qualify for a clinical trial to a second hospital, where those patients will join patients from the second hospital that qualify for the same clinical trial. Those individuals, such as doctors, that referred the clinical trial patients could be compensated through the Meaningful Use policy if the clinical trial patients improved in health due to their referral.

In another embodiment, the clinical trial sponsor can be notified of the one or more patients qualifying for the clinical trial participation from the first healthcare provider upon patient consent. In a further embodiment, the clinical trial sponsor can be notified of the one or more patients qualifying for the clinical trial participation from the second healthcare provider upon patient consent. In another embodiment, the second healthcare provider is compensated by the clinical trial sponsor upon notification of the one or more patients qualifying for the clinical trial participation.

What is claimed is:

1. A method in a medical information computing environment for utilizing a cloud-based application for notifying a healthcare provider that one or more patients from the healthcare provider qualify for clinical trial participation, the method comprising:
utilizing a cloud-based application for the following:
receiving from a clinical trial sponsor, clinical trial participation qualifications for a patient to enroll in a clinical trial;
accessing an electronic medical record (EMR) information of the one or more patients from a first healthcare provider;
screening the EMR information of the one or more patients from the first healthcare provider for matching clinical trial participation qualifications;
determining that one or more patients of the first healthcare provider qualifies for clinical trial participation of the clinical trial sponsor, wherein the qualification for clinical trial participation is based on the matching of the EMR information of the one or more patients and the clinical trial participation qualifications; and
notifying to the first healthcare provider that the one or more patients from the first healthcare provider qualifies for clinical trial participation.

2. The method of claim 1, wherein the one or more healthcare providers is a hospital.

3. The method of claim 1, wherein upon patient consent, the clinical trial sponsor is notified of the one or more patients qualifying for the clinical trial participation from the first healthcare provider.

4. The method of claim 1 further comprising:
accessing the EMR information of one or more patients from a second healthcare provider;
screening the EMR information of the one or more patients from the second healthcare provider for matching clinical trial participation qualifications;
determining that the one or more patients of the second healthcare provider that qualifies for clinical trial participation is based on the matching of the EMR information of the one or more patients and the clinical trial participation qualifications; and
notifying to the second healthcare provider that the one or more patients from the second healthcare provider qualifies for clinical trial participation.

5. The method of claim 1, wherein the notifying is the notifying of the clinical trial sponsor of a group of patients who qualify for the clinical trial.

6. The method of claim 5, wherein based on the group of patients who qualify for the clinical trial, the healthcare provider requests to participate in the clinical trial.

7. The method of claim 5, wherein the group of patients who qualify for the clinical trial are enrolled in the clinical trial of the first healthcare provider.

8. A method in a medical information computing environment for utilizing a cloud-based application for notifying one or more clinical trial sponsors that one or more patients from one or more healthcare providers fulfill clinical trial eligibility, the method comprising:
utilizing the cloud-based application for the following:
accessing an electronic medical record (EMR) for the one or more patients of the one or more healthcare providers;
uploading the clinical trial eligibility requirements of the one or more clinical trials from the one or more clinical trial sponsors;
matching the one or more patients to the one or more clinical trials in which the one or more patients are eligible to participate, based on:
(A) the EMR information of the one or more patients, and
(B) the clinical trial eligibility requirements from the one or more clinical trial sponsors;
upon a request from the one or more clinical trial sponsors for a match of the one or more patients to the one or more clinical trials, requiring a fee be paid to the one or more healthcare providers for accessing the matching of the one or more patients to the one or more clinical trials, wherein the matching indicates that the one or more patients are eligible to participate in the one or more clinical trials; and
upon payment of the fee from the one or more clinical trial sponsors, notifying the one or more clinical trial sponsors of the one or more patients that fulfill the clinical trial eligibility requirements of the one or more clinical trials.

9. The method of claim 8, wherein the one or more clinical trial sponsors is a pharmaceutical company.

10. The method of claim 8, wherein the one or more clinical trial sponsors is a college or university.

11. The method of claim 8, wherein the fee is of monetary value.

12. A method in a medical information computing environment for utilizing a cloud-based application for notifying one or more clinical trial sponsors that one or more patients of a second healthcare provider match the qualifications for one or more clinical trials, wherein at least one match was identified from a first healthcare provider, the method comprising:
utilizing the cloud-based application for the following:
accessing an electronic medical record (EMR) information for the one or more patients from the first healthcare provider;
uploading clinical trial qualifications from the one or more clinical trial sponsors;
comparing the EMR for the one or more patients of the first healthcare provider and the clinical trial qualifications from one or more clinical trial sponsors;
identifying matches between the EMR information for the one or more patients of the first healthcare provider and the clinical trial qualifications from the one or more clinical trial sponsors;
identifying a clinical trial for one or more patients of a second healthcare provider that is different than the first healthcare provider;
referring the one or more patients of the first healthcare provider to the second healthcare provider; and
notifying the one or more clinical trial sponsors that the one or more patients of the second healthcare provider match the qualifications for the one or more clinical trials, wherein at least one match was identified from the first healthcare provider.

13. The method of claim 12, wherein the one or more healthcare providers are hospitals.

14. The method of claim 13, wherein the first healthcare provider is a different hospital than the second healthcare provider.

15. The method of claim 12, wherein individuals of the first healthcare provider are compensated through the Meaningful Use policy.

16. The method of claim 12, wherein the one or more clinical trial sponsors is a pharmaceutical company.

17. The method of claim 12, wherein the one or more clinical trial sponsors is a college or university.

18. The method of claim 12, wherein upon patient consent, the clinical trial sponsor is notified of the one or more patients qualifying for the clinical trial participation from the first healthcare provider.

19. The method of claim 12, wherein upon patient consent, the clinical trial sponsor is notified of the one or more patients qualifying for the clinical trial participation from the second healthcare provider.

20. The method of claim 19, wherein the second healthcare provider is compensated by the clinical trial sponsor upon notification of the one or more patients qualifying for the clinical trial participation.
